(19) United States
(12) Patent Application Publication
(10) Pub. No.: US 2010/0118278 A1
(43) Pub. Date: May 13, 2010

(54) DIFFUSER DRIVING DEVICE AND PROJECTION-TYPE IMAGE DISPLAY APPARATUS

(75) Inventors: Izushi KOBAYASHI, Tokyo (JP); Katsuhisa ITO, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION, Tokyo (JP)

(21) Appl. No.: 12/610,921

(22) Filed: Nov. 2, 2009

(30) Foreign Application Priority Data
Nov. 12, 2008 (JP) 2008-290394

(51) Int. Cl. G02B 27/48; G02B 5/02; G03B 21/14

(52) U.S. Cl. 353/38; 359/599

(57) ABSTRACT

A diffuser driving device includes: a moving frame mounted with a diffuser; a supporting frame movably supporting the moving frame; a drive unit driving the moving frame to vibrate in a first direction perpendicular to an optical axis of an image beam incident on the diffuser and a second direction perpendicular to the first direction and the optical axis; and a controller controlling the drive unit to change a phase difference between the vibration of the moving frame in the first direction and the vibration of the moving frame in the second direction and to move the moving frame at a moving speed higher than a predetermined value.

### BACKGROUND OF THE INVENTION

1. Field of the Invention

The present invention relates to a diffuser driving device driving a diffuser and a projection-type image display apparatus performing a display operation by projecting an image to a display unit such as a screen using the diffuser driving device.

2. Description of the Related Art

A projection-type image display apparatus such as a projector is known as an image display apparatus capable of magnifying and displaying an image.

The projection-type image display apparatus displays an image by projecting light from a light source to a screen. The projection-type image display apparatus is configured so that an observer can watch the image projected on the screen.

In the past, for example, a high-luminance projection tube was used as the light source of the projection-type image display apparatus. An image was projected on the screen by projecting light from the light source through a liquid crystal panel on which the image had been displayed, but the brightness or the color reproducibility was not satisfactory. Therefore, for the purpose of easy modulation based on an image signal, excellent color reproducibility, and guarantee of the brightness, a projection-type image display apparatus using color laser beams of red, green, and blue as a light source was suggested.

In such a projection-type image display apparatus using the laser beams as a light source, granular noise called speckle noise is generated on a screen, thereby markedly deteriorating the image quality. This is because a laser speckle phenomenon occurs due to a high coherence of the laser beams. For example, when the laser beams are applied to a rough surface of a screen or the like, granular or spot-like interference patterns are generated.

In the image display apparatus using the laser beams as a light source, a technique of reducing the speckle noise is described, for example, in Japanese Unexamined Patent Application Publication No. 6-208089. In Japanese Unexamined Patent Application Publication No. 6-208089, a rotatably-supported diffuser is disposed in an optical path of the laser beams. An image beam (two-dimensional intermediate image) is incident on the diffuser using the laser beams. In Japanese Unexamined Patent Application Publication No. 6-208089, temporally different speckle patterns are generated by rotating and driving the diffuser. Accordingly, the speckle noise may not be visible due to the average effect of eyes.

### SUMMARY OF THE INVENTION

In the past, dust might be attached to the diffuser or a pattern defect might be generated. When the dust is attached to the diffuser or the pattern defect is generated, the dust or the pattern defect is displayed on the screen, thereby causing deterioration in image quality. Accordingly, so as not to allow a user to recognize the dust or the pattern defect, it is desirable to drive the diffuser in a track in which the diffuser does not pass through the same locus for a predetermined time (for example, 1 second).

However, in the technique of reducing the speckle noise described in Japanese Unexamined Patent Application Publication No. 6-208089, the diffuser is rotated in one direction. That is, a point of the diffuser described in Japanese Unexamined Patent Application Publication No. 6-208089 passes through the same locus in a very short period. Accordingly, the dust attached to the diffuser or the pattern defect draws the same locus in the two-dimensional intermediate image applied to the diffuser. As a result, the dust or the pattern defect is recognized by a user as a circular line on the screen to which the image is projected, thereby causing the deterioration in image quality.

The projection-type image display apparatus in which a diffuser is rotated uses a diffuser greater than the size of the image beam (two-dimensional intermediate image). Accordingly, the increase in size of the entire apparatus and the cost-up may be caused. When the diffuser is rotated and driven, a surface wobbling in the optical axis of the beam is caused in the diffuser. When the surface wobbling is caused in the diffuser, the further deterioration in image quality is caused. Therefore, the eccentricity adjustment is necessary for reducing the surface wobbling of the rotating diffuser and the assembly adjustment thus takes much time.

It is desirable to provide a diffuser driving device and a projection-type image display apparatus, which can suppress the influence of the deterioration in image quality due to dust attached to the diffuser or a pattern defect.

According to an embodiment of the invention, there is provided a diffuser driving device including: a moving frame mounted with a diffuser; a supporting frame movably supporting the moving frame; a drive unit driving the moving frame to vibrate in a first direction perpendicular to an optical axis of an image beam incident on the diffuser and a second direction perpendicular to the first direction and the optical axis; and a controller controlling the drive unit to change a phase difference between the vibration of the moving frame in the first direction and the vibration of the moving frame in the second direction and to move the moving frame at a moving speed higher than a predetermined value.

According to another embodiment of the invention, there is provided a projection-type image display apparatus including: an optical block forming and projecting an image beam; a projection lens magnifying and projecting the image beam to a display unit; and a diffuser driving device being disposed between the optical block and the projection lens and including a diffuser on which the image beam from the optical block is incident.

Here, the diffuser driving device includes a moving frame mounted with the diffuser, a supporting frame movably supporting the moving frame, a drive unit driving the moving frame to vibrate in a first direction perpendicular to the optical axis of the image beam incident on the diffuser and a second direction perpendicular to the first direction and the optical axis, and a controller controlling the driving unit to change a phase difference between the vibration of the moving frame in the first direction and the vibration of the moving frame in the second direction and to move the moving frame at a moving speed higher than a predetermined value.

In the diffuser driving device and the projection-type image display apparatus according to the embodiments of the invention, the phase difference between the vibration of the moving frame in the first direction and the vibration of the moving frame in the second direction is changed. Accordingly, it is possible to extend the interval between the times when a point of the diffuser passes through the same locus. That is, it is possible to drive the diffuser in the track not passing through the same locus for a predetermined time. As a result, since the dust attached to the diffuser or the pattern defect can hardly be recognized by a user, it is possible to suppress the influence of the deterioration in image quality.

### BRIEF DESCRIPTION OF THE DRAWINGS

FIG. 1 is a diagram schematically illustrating the configuration of a projection-type image display apparatus according to an embodiment of the invention.

FIG. 2 is a perspective view illustrating a diffuser driving device according to a first embodiment of the invention.

FIG. 3 is an exploded perspective view of the diffuser driving device according to the first embodiment of the invention as viewed from the front side.

FIG. 4 is an exploded perspective view of the diffuser driving device according to the first embodiment of the invention as viewed from the rear side.

FIG. 5 is a diagram illustrating a section of the diffuser driving device according to the first embodiment of the invention.

FIG. 6 is a plan view schematically illustrating the diffuser driving device according to the first embodiment of the invention.

FIG. 7 is a block diagram illustrating the circuit configuration of a controller of the diffuser driving device according to the first embodiment of the invention.

FIG. 8 is a graph illustrating control signals output to a first drive unit and a second drive unit of the diffuser driving device according to the first embodiment of the invention.

FIG. 9 is a graph illustrating a phase difference between the control signals output to the first drive unit and the second drive unit of the diffuser driving device according to the first embodiment of the invention.

FIG. 10 is a diagram illustrating a driving locus of a point of a diffuser of the diffuser driving device according to the first embodiment of the invention.

FIG. 11 is a plan view schematically illustrating a diffuser driving device according to a second embodiment of the invention.

FIG. 12 is a diagram illustrating a partial section of the diffuser driving device according to the second embodiment of the invention.

### DESCRIPTION OF THE PREFERRED EMBODIMENTS

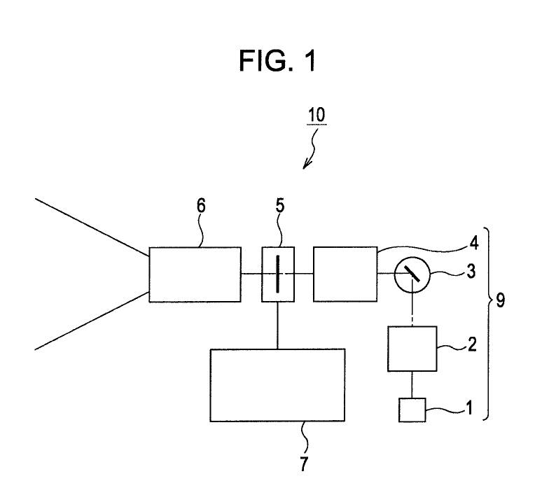

Hereinafter, embodiments of the invention will be described with reference to FIGS. 1 to 12. In the drawings, common elements are referenced by like reference numerals and signs. The invention is not limited to the embodiments.

### 1. First Embodiment

### Configuration of Projection-Type Image Display Apparatus

A projection-type image display apparatus according to a first embodiment of the invention will be described now with reference to FIG. 1. FIG. 1 is a diagram schematically illustrating the configuration of a projection-type image display apparatus according to an embodiment of the invention.

The projection-type image display apparatus shown in FIG. 1 includes a one-dimensional light modulator 1, an Offner relay 2, a Galvano mirror 3, a field curvature correcting optical system 4, a diffuser driving device 5, and a projection lens 6. The one-dimensional light modulator 1 includes plural pixels arranged in a direction perpendicular to the paper plane.

A phase-reflecting diffraction grating such as a GLV (Grating Light Valve) device can be used as the one-dimensional light modulator 1. When the GLV device is used, the device itself does not emit light and thus uses a light source and an optical system for projecting light from the light source to the device. Here, it is preferable that a coherent light source is used as the light source. The Offner relay 2 is disposed in a side to which the light is emitted from the one-dimensional light modulator 1.

The Offner relay 2 is a relay optical system using a combination of reflecting mirrors. The Offner relay 2 serves to form an equivalent-magnification image of a one-dimensional image. The Offner relay 2 includes a primary mirror and a secondary mirror.

The primary mirror is a concave mirror of which the concave surface is directed to the one-dimensional light modulator 1 and takes charge of first and third reflections of the light from the one-dimensional light modulator 1. The secondary mirror is a concave mirror of which the concave surface is directed to the primary mirror and takes charge of a second reflection.

The light incident on the Offner relay 2 from the one-dimensional light modulator 1 is first reflected by the primary mirror, arrives at the secondary mirror, is secondly reflected by the secondary mirror, and travels to the primary mirror again. The light thirdly reflected by the primary mirror travels to the Galvano mirror 3.

The Galvano mirror 3 is a panel-like mirror and is disposed in front of an imaging position of the Offner relay 2. The Galvano mirror 3 includes a light scanning unit for scanning the one-dimensional image in synchronization with an image signal. The Galvano mirror 3 can perform the scanning operation by rotating the panel-like mirror by the use of a driving mechanism (such as an actuator) not shown in the plane perpendicular to the arrangement direction of the one-dimensional light modulator 1.

At this time, by modulating the light with the one-dimensional light modulator 1 on the basis of the image signal corresponding to a scanning angle of the Galvano mirror 3, it is possible to obtain a two-dimensional image, which is formed by the scanning in the direction perpendicular to the plane including the one-dimensional image, from the one-dimensional image. The two-dimensional image is formed on a cylindrical surface centered on the rotational axis of the Galvano mirror 3.

In this way, when the two-dimensional image formed on the cylindrical surface is projected without any change, it is not possible to correctly display an image on a planar screen. Therefore, the field curvature correcting optical system 4 is disposed at the position of the two-dimensional image formed by the Galvano mirror 3. By allowing the two-dimensional image to pass through the field curvature correcting optical system 4, it is possible to form a planar two-dimensional intermediate image. For example, the field curvature correcting optical system 4 can employ a cylindrical lens.

The one-dimensional light modulator 1, the Offner relay 2, the Galvano mirror 3, and the field curvature correcting optical system 4 constitute an optical block 9. The optical block 9 forms the two-dimensional intermediate image as an image beam as described above. The optical block 9 projects the formed two-dimensional intermediate image to the diffuser driving device 5 and the projection lens 6.

The projection lens 6 serves to magnify and project the formed planar two-dimensional intermediate image onto the screen. The diffuser driving device 5 is disposed at a position where the planar two-dimensional intermediate image is formed between the field curvature correcting optical system 4 and the projection lens 6.

### Configuration of Diffuser Driving Device

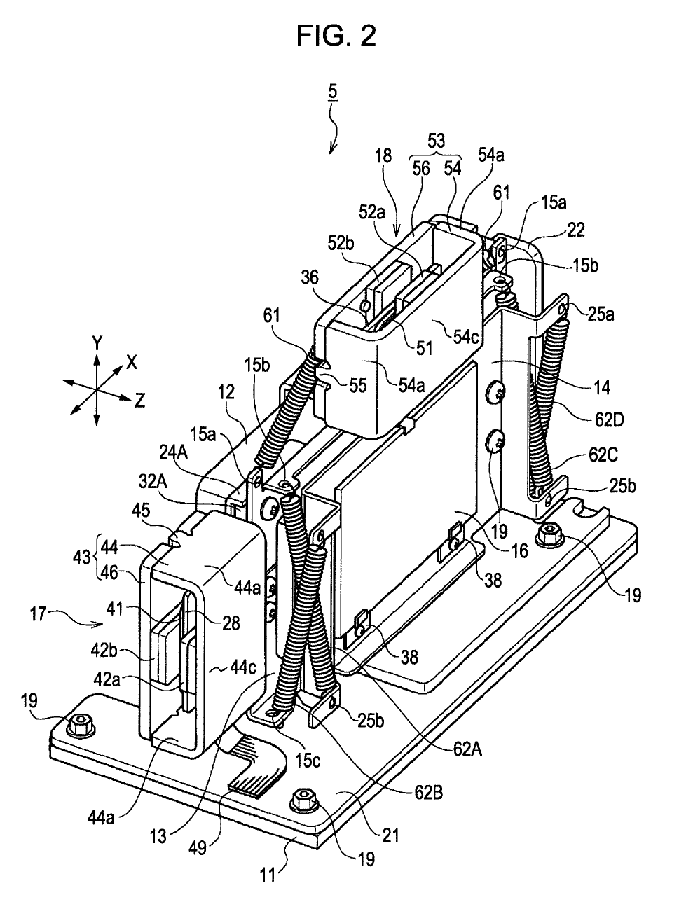

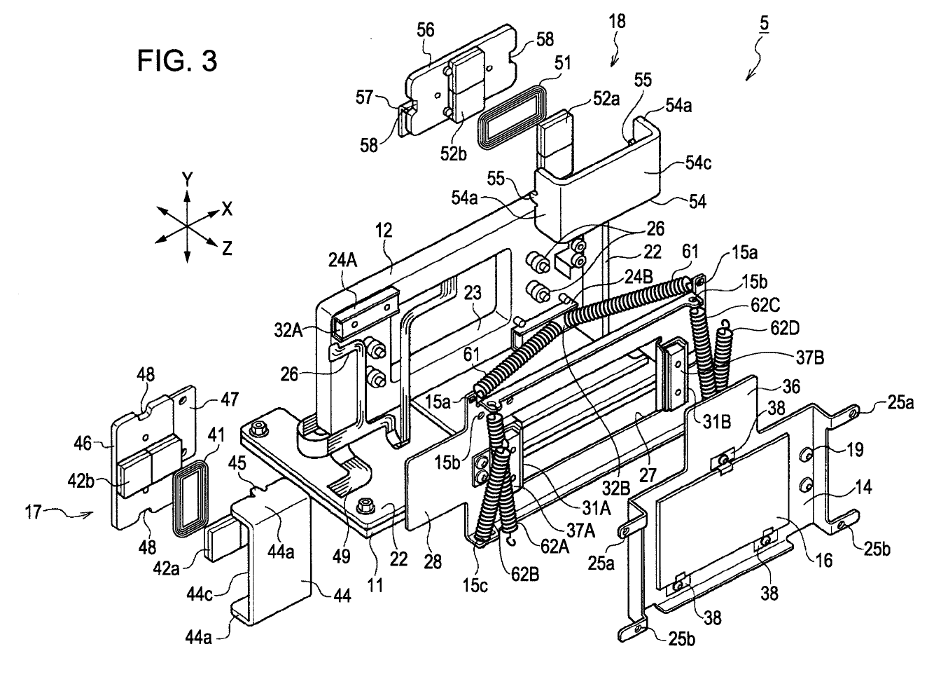

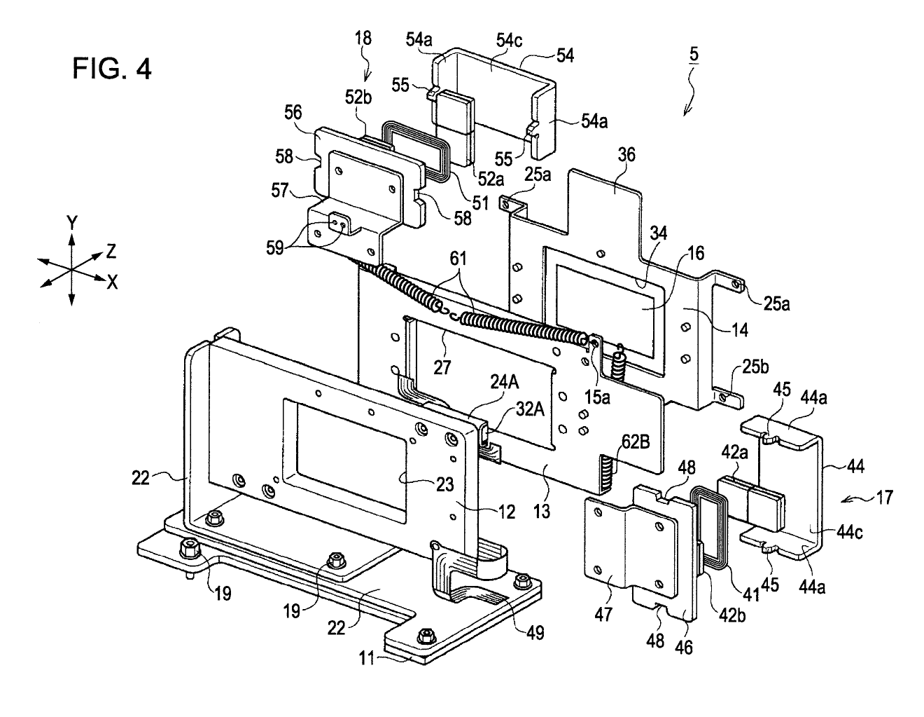

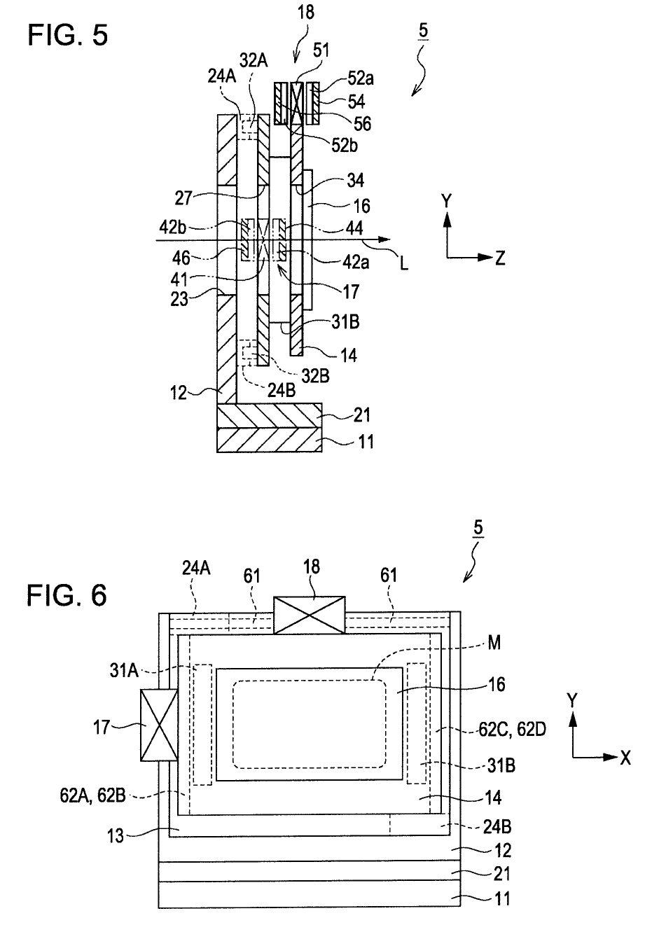

A diffuser driving device according to a first embodiment (hereinafter, referred to as “this embodiment”) of the invention will be described now with reference to FIGS. 2 to 6. FIG. 2 is a perspective view illustrating the diffuser driving device according to this embodiment, FIGS. 3 and 4 are exploded perspective views illustrating the diffuser driving device according to this embodiment. FIG. 5 is a diagram illustrating a section of the diffuser driving device according to this embodiment. FIG. 6 is a plan view schematically illustrating the diffuser driving device according to this embodiment.

As shown in FIGS. 2 to 4, the diffuser driving device 5 includes a fixing base 11, a supporting frame 12, a first moving frame 13, a second moving frame 14, a diffusing plate (hereinafter, referred to as “diffuser”) 16, two drive units 17 and 18, and a controller 7.

The first moving frame 13 is supported by the supporting frame 12 so as to be movable in a first direction X perpendicular to a third direction Z parallel to the optical axis L of the optical system. The second moving frame 14 is supported by the first moving frame 13 so as to be movable in a second direction Y perpendicular to the third direction Z and the first direction X. That is, as shown in FIGS. 2 and 5, three members of the supporting frame 12, the first moving frame 13, and the second moving frame 14 are assembled in a tower shape in the third direction Z.

The fixing base 11 is formed substantially in a panel shape having a rectangular plane portion. The fixing base 11 is fixed to the main body of the projection-type image display apparatus 10 by a fixing method using plural fixing screws 19 and the like. A positioning base 21 is formed on the planar portion of the fixing base 11 in an overlapping manner.

The positioning base 21 has substantially a panel shape. The positioning base 21 are provided with plural fixing holes. Although not shown in the drawings, the plural fixing holes are longitudinal holes having an elliptical shape. The positioning base 21 is fixed to the fixing base 11 by a fixing method using fixing screws 19. The positioning base 21 is provided with a fixing portion 22 substantially having an L shape. The fixing portion 22 is fixed to the positioning base 21 by a fixing method using fixing screws 19 or the like. The supporting frame 12 is fixed to the fixing portion 22 by a fixing method using fixing screws or the like.

The positioning base 21 can adjust the initial position in the third direction Z of the supporting frame 12 using the longitudinal fixing holes. The positioning base 21 can adjust the initial positions of a rotation angle X-ro of the supporting frame 12 about the first direction X and a rotation angle Y-ro about the second direction Y by the use of the fixing portion 22 having an L shape. As a result, by disposing the positioning base 21 between the fixing base 11 and the supporting frame 12, the positioning and the angle adjustment between the pattern plane of the diffuser 16 and the two-dimensional intermediate image projected from the field curvature correcting optical system 4 can be carried out.

The supporting frame 12 is formed substantially of a rectangular panel. A substantially rectangular opening 23 is formed at the center of the supporting frame 12. The opening area of the opening 23 is substantially equal to or slightly greater than the size of the two-dimensional intermediate image. The supporting frame 12 is fixed to the fixing portion 22 of the positioning base 21 in such a manner that the longitudinal direction is parallel to the first direction X. Accordingly, as shown in FIGS. 3 and 4, the open side of the opening 23 of the supporting frame 12 is directed to the third direction Z.

The supporting frame 12 includes two rail members 24A and 24B and four magnets 26. The two rail members 24A and 24B support the first moving frame 13 so as to move (vibrate) parallel to the first direction X. The two rail members 24A and 24B have a section of an U shape. Sliding members 32A and 32B to be described later and attached to the first moving frame 13 slidably engage with the concave portions of the U shapes of the two rail members 24A and 24B.

As shown in FIGS. 3 and 6, the first rail member 24A is disposed on one side in the short-side direction of the planar portion of the supporting frame 12 and one side in the longitudinal direction. The longitudinal direction of the first rail member 24A is substantially parallel to the longitudinal direction of the supporting frame 12, that is, the first direction X.

The second rail member 24B is disposed on the other side in the short-side direction of the planar portion of the supporting frame 12 and the other side in the longitudinal direction. That is, the second rail member 24B is disposed at a diagonal corner of the supporting frame 12 relative to the first rail member 24A. The longitudinal direction of the second rail member 24B is substantially parallel to the longitudinal direction of the supporting frame 12, that is, the first direction X. In this way, the first rail member 24A and the second rail member 24B are disposed outside the opening 23 in the longitudinal direction and the short-side direction.

As shown in FIG. 3, the four magnets 26 are arranged so that two magnets are disposed on both sides of the longitudinal direction of the opening 23, respectively, with the opening 23 interposed therebetween. The magnets 26 are interposed between the supporting frame 12 and the first moving frame 13. The magnets 26 serve to reduce the vibration in the third direction Z of the first moving frame 13 at the time of driving by means of their attractive forces. Accordingly, it is possible to suppress the surface wobbling in the third direction Z parallel to the optical axis L at the time of driving, thereby obtaining an excellent focus of a projection image.

The first moving frame 13 is formed substantially of a rectangular panel-like member. Both ends of the first moving frame 13 in the short-side direction are substantially bent perpendicularly. Both upper ends of the first moving frame 13 are provided with a first upper locking hole 15a and a second upper locking hole 15b. Both lower ends of the first moving frame 13 are provided with lower locking holes 15c.

A first opening window 27 substantially having a rectangular shape is substantially formed at the center of the first moving frame 13. The opening area of the first opening window 27 is substantially equal to or slightly greater than the opening area of the opening 23 formed in the supporting frame 12. As shown in FIG. 5, when the first moving frame 13 and the supporting frame 12 overlap with each other, the first opening window 27 is opposed to the opening 23 of the supporting frame 12. The first moving frame 13 includes a first attachment piece 28 at one end in the longitudinal direction thereof. The first attachment piece 28 has a tongue shape and protrudes from the substantial center of the short side of the first moving frame 13.

The first moving frame 13 includes two rail members 31A and 31B and two sliding members 32A and 32B. The two rail members 31A and 31B has a section of an U shape, similarly to the two rail members 24A and 24B of the supporting frame 12. Sliding members 37A and 37B to be described attached to the second moving frame 14 slidably engage with the concave portions of the U shapes of the two rail members 31A and 31B.

As shown in FIGS. 3 and 6, the third rail member 31A and the fourth rail member 31B are disposed on both sides in the longitudinal direction of the first opening window 27 with the first opening window 27 interposed therebetween. The third rail member 31A is disposed on one side in the longitudinal direction of the first opening window 27. The fourth rail member 31B is disposed on the other side in the longitudinal direction of the first opening window 27. The longitudinal directions of the third rail member 31A and the fourth rail member 31B are substantially parallel to the short-side direction of the first moving frame 13, that is, the second direction Y.

The two sliding members 32A and 32B are formed substantially in a rectangular hexahedral shape. The two sliding members 32A and 32B are attached to the rear surface of the first moving frame 13 which is the opposite of the surface to which the two rail members 31A and 31B are attached. The first sliding member 32A is disposed on one side in the short-side direction of the rear surface of the first moving frame 13 and one side in the longitudinal direction thereof. The longitudinal direction of the first sliding member 32A is substantially parallel to the longitudinal direction of the first moving frame 13, that is, the first direction X. The first sliding member 32A is fixed to the first moving frame 13 by a fixing method using fixing screws or the like.

The second sliding member 32B is disposed on the other side in the short-side direction of the rear surface of the first moving frame 13, that is, on the other side in the longitudinal direction thereof. That is, the second sliding member 32B is disposed at a diagonal corner of the first moving frame 13 relative to the first sliding member 32A. The longitudinal direction of the second sliding member 32B is substantially parallel to the longitudinal direction of the first moving frame 13, that is, the first direction X. The second sliding member 32B is fixed to the first moving frame 13 by a fixing method using fixing screws or the like. The fixing method of the first and second sliding members 32A and 32B is not limited to the method using the fixing screws. For example, the first and second sliding members 32A and 32B may be fixed by welding.

When the supporting frame 12 overlaps with the first moving frame 13, the first sliding member 32A slidably engages with the first rail member 24A disposed in the supporting frame 12. The first rail member 24A and the first sliding member 32A constitute a specific example of the guide member in the claims. Similarly, the second sliding member 32B slidably engages with the second rail member 24B disposed in the supporting frame 12. The second rail member 24B and the second sliding member 32B constitute a specific example of the guide member in the claims. Accordingly, the first moving frame 13 is guided by the first rail member 24A and the second rail member 24B so as to move substantially parallel to the first direction X.

The second moving frame 14 is formed substantially of a rectangular panel-like member. Both ends of the second moving frame 14 in the longitudinal direction are substantially bent perpendicularly. Both upper ends of the second moving frame 14 are provided with upper locking holes 25a. Both lower ends of the second moving frame 14 are provided with lower locking holes 25b.

Similarly to the first moving frame 13, the second opening window 34 substantially having a rectangular shape is substantially formed at the center of the second moving frame 14. The opening area of the second opening window 34 is substantially equal to the opening area of the first opening window 27. As shown in FIG. 5, when the supporting frame 12, the first moving frame 13, and the second moving frame 14 overlap with each other, the second opening window 34 is opposed to the opening 23 and the first opening window 27. The second moving frame 14 includes a second attachment piece 36 at one end in the short-side direction thereof. The second attachment piece 36 has a tongue shape and protrudes from the substantial center of the long side of the second moving frame 14.

The second moving frame 14 includes two sliding members 37A and 37B and plural fasteners 38. The two sliding members 37A and 37B are substantially formed in a rectangular hexahedral shape. When the second moving frame 14 overlaps with the first moving frame 13, the two sliding members 37A and 37B are attached to the rear surface of the second moving frame 14 opposed to the first moving frame 13.

The third sliding member 37A and the fourth sliding member 37B are disposed on both sides in the longitudinal direction of the second opening window 34 with the second opening window 34 interposed therebetween. The third sliding member 37A is disposed on one side in the longitudinal direction of the second opening window 34. The fourth sliding member 37B is disposed on the other side in the longitudinal direction of the second opening window 34. The longitudinal directions of the third sliding member 37A and the fourth sliding member 37B are substantially parallel to the short-side direction of the second moving frame 14, that is, the second direction Y.

The third sliding member 37A and the fourth sliding member 37B are fixed to the first moving frame 13 by a fixing method using fixing screws or the like. The fixing method of the third and fourth sliding members 37A and 37B is not limited to the method using the fixing screws. For example, the third and fourth sliding members 37A and 37B may be fixed by welding.

When the second moving frame 14 overlaps with the first moving frame 13, the third sliding member 37A slidably engages with the third rail member 31A disposed in the first moving frame 13. The third rail member 31A and the third sliding member 37A constitute a specific example of the guide member in the claims. Similarly, the fourth sliding member 37B slidably engages with the fourth rail member 31B disposed in the first moving frame 13. The fourth rail member 31B and the fourth sliding member 37B constitute a specific example of the guide member in the claims. Accordingly, the second moving frame 14 is guided by the third rail member 31A and the fourth rail member 31B so as to move substantially parallel to the second direction Y.

In this embodiment, the rail members and the sliding members are used as a specific example of the guide member guiding the first moving frame 13 and the second moving frame 14. However, the guide member guiding the first moving frame 13 and the second moving frame 14 is not limited to the rail members and the sliding members. For example, the guide member may include a sliding shaft formed of a rod-like member and a bearing guiding the sliding shaft to be slidable.

The plural fasteners 38 are disposed around the second opening window 34. The diffuser 16 is fixed, for example, by a fixing method using fixing screws or the like, so as to cover the second opening window 34 with the plural fasteners 38. That is, the diffuser 16 is substantially perpendicular to the third direction Z. The method of fixing the diffuser 16 is not limited to the fixing screws, but for example, may employ an adhesive.

The diffuser 16 is substantially a rectangular panel-like member. As shown in FIG. 6, the surface area of the diffuser 16 is set to be slightly greater than the area of the two-dimensional intermediate image M. The diffuser 16 has plural concave and convex portions on the surface thereof. In this way, by forming the concave and convex patterns on the surface of the diffuser 16, the light passing through the diffuser 16 is subjected to the spatial phase modulation corresponding to the concave and convex patterns. The speckle noise pattern of a projected image projected onto the screen varies depending on the phase of the light. Therefore, temporally varying phase modulation can be realized by driving (moving) the diffuser 16. Accordingly, since the speckle pattern on the screen varies, it is possible to reduce the noise by the average effect of human eyes.

The diffuser 16 can be manufactured by employing a transparent material such as a glass substrate and forming repeated concave and convex patterns by photolithography.

As shown in FIGS. 5 and 6, the two-dimensional intermediate image from the field curvature correcting optical system 4 passes through the opening 23, the first opening window 27, and the second opening window 34 along the optical axis L. The two-dimensional intermediate image is projected on the diffuser 16 and the two-dimensional intermediate image M is formed on the patterned plane of the diffuser 16.

Here, as shown in FIG. 6, the first rail member 24A and the first sliding member 32A are disposed to avoid the upside of the opening 23 and the first opening window 27. The third and fourth rail members 31A and 31B and the third and fourth sliding members 37A and 37B are disposed on both ends of the first opening window 27 and the second opening window 34. That is, the sliding mechanism guiding the first moving frame 13 and the second moving frame 14 are disposed to avoid the upside (the upper portion in the gravitational direction) in the optical path. Accordingly, when the rail members and the sliding members slide relative to each other to generate abrasion particles, it is possible to suppress or prevent the abrasion particles from being dropped to the optical path. As a result, it is possible to prevent the abrasion particles from being attached to the patterned surface of the diffuser 16 and to form a clear two-dimensional intermediate image M on the patterned surface of the diffuser 16.

Two drive units 17 and 18 will now be described. The two drive units 17 and 18 have the same configuration. The two drive units 17 and 18 employ a voice coil motor (hereinafter, referred to as “VCM”) method.

The first drive unit 17 includes a first coil 41, two magnets 42a and 42b, and a first yoke 43. The first drive unit 17 drives the first moving frame 13 to move (vibrate) in the first direction X.

As shown in FIGS. 3 and 4, the first coil 41 is formed of a flat coil which is wound substantially two-dimensionally in an elliptical shape and which includes substantially a rectangular space at the center thereof. As shown in FIG. 2, the first coil 41 is disposed in the first attachment piece 28 of the first moving frame 13 with a flexible circuit board 49 interposed therebetween. The first coil 41 is attached by a fixing mechanism such as soldering to form a body with the flexible circuit board 49. Accordingly, the first coil 41 is electrically connected to the wiring patterns disposed in the flexible circuit board 49.

Here, in the first coil 41, two linear portions on the long sides opposed to each other in the width direction serve to a thrust generator generating a thrust force of an actuator. In the first coil 41 of the first drive unit 17, the extending direction of the thrust generator is perpendicular to the first direction X.

The first yoke 43 is formed of a flat cylindrical member. The first yoke 43 includes a first yoke member 44 and a second yoke 46. The first yoke member 44 is formed substantially in an U shape. The first yoke member 44 includes two opposed pieces 44a and 44a opposed to each other and a connection piece 44c connecting both opposed pieces 44a and 44a. Engaging claws 45 are formed in both opposed pieces 44a and 44a in the first yoke member 44, respectively. The first magnet 42a is integrally fixed to the connection piece 44c of the first yoke member 44 by a fixing method using an adhesive or the like.

On the contrary, the second yoke member 46 has a panel shape. Engaging portions 48 engaging with the two engaging claws 45 of the first yoke member 44 are formed at both ends in the longitudinal direction of the second yoke member 46. The second magnet 42b is integrally fixed to the second yoke member 46 by a fixing method using an adhesive or the like. A fixing member 47 for fixation to the supporting frame 12 is attached to the opposite surface of the surface, in which the second magnet 42b is disposed, in the second yoke member 46. The fixing member 47 is fixed to one side in the longitudinal direction of the supporting frame 12 by a fixing method using fixing screws or the like.

When the engaging claws 45 of the first yoke member 44 engage with the engaging portions 48 of the second yoke member 46, the first magnet 42a is opposed to the second magnet 42b. At this time, the first magnet 42a and the second magnet 42b have different magnetic polarities. As shown in FIGS. 2 and 5, the first coil 41 attached to the first moving frame 13 is disposed in the space between the first magnet 42a and the second magnet 42b.

In this way, the magnetic force due to the first magnet 42a and the second magnet 42b acts in a direction perpendicular to the first coil 41. As a result, when current flows in the first coil 41, a thrust force directed to the first direction X is generated in the first drive unit 17 by the Fleming's left-hand rule.

The second drive unit 18 includes a second coil 51, two magnets 52a and 52b, and a second yoke 53. The second drive unit 18 drives the second moving frame 14 to move (vibrate) in the second direction Y.

As shown in FIGS. 3 and 4, similarly to the first coil 41, the second coil 51 is formed of a flat coil which is wound substantially two-dimensionally in an elliptical shape and which includes substantially a rectangular space at the center thereof. As shown in FIG. 2, the second coil 51 is disposed in the second attachment piece 36 of the second moving frame 14 with a flexible circuit board 49 interposed therebetween. The second coil 51 is attached by a fixing mechanism such as soldering to form a body with the flexible circuit board 49. Accordingly, the second coil 51 is electrically connected to the wiring patterns disposed in the flexible circuit board 49.

Here, similarly to the first coil 41, in the second coil 51, two linear portions on the long sides opposed to each other in the width direction serve to a thrust generator generating a thrust force of an actuator. In the second coil 51 of the second drive unit 18, the extending direction of the thrust generator is perpendicular to the second direction Y.

The second yoke 53 is formed of a flat cylindrical member. The second yoke 53 includes a first yoke member 54 and a second yoke member 56. The first yoke member 54 is formed substantially in an U shape. The first yoke member 54 includes two opposed pieces 54a and 54a opposed to each other and a connection piece 54c connecting both opposed pieces 54a and 54a. Engaging claws 55 are formed in both opposed pieces 54a and 54a in the first yoke member 54, respectively. The first magnet 52a is integrally fixed to the connection piece 54c of the first yoke member 54 by a fixing method using an adhesive or the like.

On the contrary, the second yoke member 56 has a panel shape. Engaging portions 58 engaging with the two engaging claws 55 of the first yoke member 54 are formed at both ends in the longitudinal direction of the second yoke member 56. The second magnet 52b is integrally fixed to the second yoke member 56 by a fixing method using an adhesive or the like. A fixing member 57 for fixation to the supporting frame 12 is attached to the opposite surface of the surface, in which the second magnet 52b is disposed, in the second yoke member 56. The fixing member 57 is fixed to one side in the short-side direction of the supporting frame 12 by a fixing method using fixing screws or the like. Two locking holes 59 are formed in the fixing member 57.

When the engaging claws 55 of the first yoke member 54 engage with the engaging portions 58 of the second yoke member 56, the first magnet 52a is opposed to the second magnet 52b. At this time, the first magnet 52a and the second magnet 52b have different magnetic polarities. As shown in FIGS. 2 and 5, the second coil 51 attached to the first moving frame 13 is disposed in the space between the first magnet 52a and the second magnet 52b.

In this way, the magnetic force due to the first magnet 52a and the second magnet 52b acts in a direction perpendicular to the second coil 51. As a result, when current flows in the second coil 51, a thrust force directed to the second direction Y is generated in the second drive unit 18 by the Fleming's left-hand rule.

In this embodiment, the VCM method is used as the driving method of the first drive unit 17 and the second drive unit 18, but the driving method is not limited to the VCM method. For example, a piezoelectric device, a shape-memory alloy, or an eccentric cam mechanism may be employed as the driving method of the first drive unit 17 and the second drive unit 18.

The first drive unit 17 and the second drive unit 18 having the above-mentioned configuration are electrically connected to the controller 7 via the flexible circuit board 49.

As shown in FIG. 2, the supporting frame 12 and the first moving frame 13 are connected to each other with two tension coil springs 61 as a specific example of the urging member. Ends in the longitudinal direction of the two tension coil springs 61 are locked to the first upper locking holes 15a formed at both upper ends of the first moving frame 13. The other ends in the longitudinal direction of the two tension coil springs 61 are locked to the locking holes 59 of the fixing member 57 fixed to the supporting frame 12.

The two tension coil springs 61 urge the first moving frame 13 to the supporting frame 12. Accordingly, the first and second rail members 24A and 24B and the first and second sliding members 32A and 32B are typically urged in the third direction Z during the driving. Accordingly, it is possible to suppress or prevent the surface wobbling of the first moving frame 13 in the third direction Z which is the optical axis direction at the time of driving.

The first moving frame 13 and the second moving frame 14 are connected to each other with four tension coil springs 62A, 62B, 62C, and 62D. The first tension coil spring 62A and the second tension coil spring 62B are disposed at one end in the longitudinal direction of the first moving frame 13 and the second moving frame 14. The third tension coil spring 62C and the fourth tension coil spring 62D are disposed at the other end in the longitudinal direction of the first moving frame 13 and the second moving frame 14.

One end in the longitudinal direction of the first tension coil spring 62A is locked to the second upper locking hole 15b disposed in the upper portion of the first moving frame 13. The other end in the longitudinal direction of the first tension coil spring 62A is locked to the lower locking hole 25b of the second moving frame 14. One end in the longitudinal direction of the second tension coil spring 62B is locked to the upper locking hole 25a of the second moving frame 14. The other end in the longitudinal direction thereof is locked to the lower locking hole 15c of the first moving frame 13. That is, the first tension coil spring 62A and the second tension coil spring 62B intersect each other on one side in the longitudinal direction of the first moving frame 13 and the second moving frame 14.

Similarly, the third tension coil spring 62C and the fourth tension coil spring 62D intersect each other on the other side in the longitudinal direction of the first and second moving frames 13 and 14.

The four tension coil springs 62A, 62B, 62C, and 62D urge the second moving frame 14 to the first moving frame 13. Accordingly, the third and fourth rail members 31A and 31B and the third and fourth sliding members 37A and 37B are typically urged in the third direction Z during the driving. Accordingly, it is possible to suppress or prevent the surface wobbling of the second moving frame 14 in the third direction Z at the time of driving, similarly to the first moving frame 13. As a result, it is possible to reduce the surface wobbling in the direction perpendicular to the diffuser 16 with a very simple configuration, thereby acquiring an excellent image.

In this way, in the diffuser driving device 5 according to this embodiment, the tension coil springs 61 and 62A to 62D are disposed in the first direction X and the second direction Y. Accordingly, when the two drive units 17 and 18 are not driven, it is possible to return the first moving frame 13 and the second moving frame 14 to the vicinity of the stroke center by means of the elastic forces of the tension coil springs 61 and 62A to 62D. The elastic forces of the tension coil springs 61 and 62A to 62D assist the vibration driving of the first drive unit 17 and the second drive unit 18. As a result, it is possible to reduce the power consumption of the first drive unit 17 and the second drive unit 18.

In this embodiment, the tension coil springs are used as the urging member, but the invention is not limited to the tension coil springs. For example, by employing magnets as the urging member, the first moving frame 13 and the second moving frame 14 may be urged to the supporting frame 12 by means of the attractive force of the magnets.

### Configuration of Diffuser Driving Device

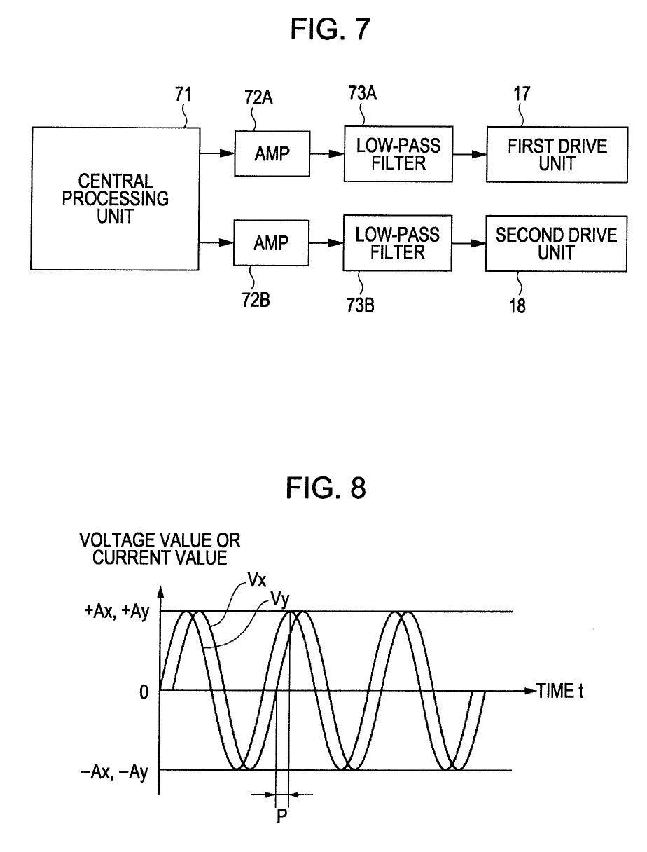

The circuit configuration of the diffuser driving device will be described now with reference to FIG. 7. FIG. 7 is a block diagram illustrating the control concept of the diffuser driving device 5. The controller 7 includes a central processing unit (micro computer) 71, two amplifiers (AMP) 72A and 72B, and two low-pass filters (LPF) 73A and 73B. The central processing unit 71 is electrically connected to the first drive unit 17 via the first amplifier 72A and the first low-pass filter 73A. The central processing unit 71 is electrically connected to the second drive unit 18 via the second amplifier 72B and the second low-pass filter 73B. The central processing unit 71 outputs control signals to be described later to the first drive unit 17 and the second drive unit 18.

### Driving Example of Controller and Operation of Diffuser Driving Device

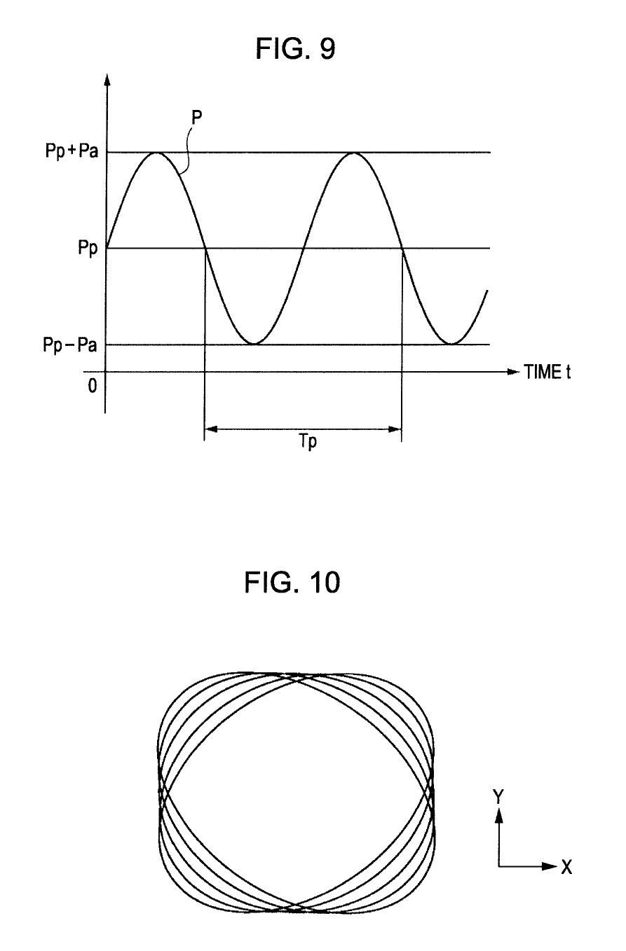

The driving control of the controller 7 on the first drive unit 17 and the second drive unit 18 will be described now with reference to FIGS. 7 and 10.

FIG. 8 is a diagram illustrating the control signals output to the first drive unit and the second drive unit at a certain instant, FIG. 9 is a diagram illustrating a phase difference between the control signals output to the first drive unit and the second drive unit, and FIG. 10 is a diagram illustrating the driving locus of a point in the diffuser.

When dust is attached to the diffuser 16 or a pattern defect is generated, it is necessary to drive the diffuser 16 in such a track that the diffuser does not pass through the same locus for a predetermined time, so as not to allow a user to recognize the dust or the pattern defect. Therefore, in the diffuser driving device 5 according to this embodiment, the controller 7 controls the first drive unit 17 and the second drive unit 18 to drive the diffuser 16 as follows.

The central processing unit 71 of the controller 7 shown in FIG. 7 calculates a voltage value or a current value Vx using Expression 1 and outputs the calculated voltage value or current value Vx to the first drive unit 17. Here, Ax represents the maximum value of the voltage or current applied to the first drive unit 17 and Tx represents the period of a basic vibration of the first drive unit 17. In addition, t represents the time and P represents the phase difference given for the control of the first drive unit 17 and the second drive unit 18.

Vx=Ax×sin(2π×t/Tx+P) Expression 1

Similarly, the central processing unit 71 calculates a voltage value or a current value Vy using Expression 2 and outputs the calculated voltage value or current value Vy to the second drive unit 18. Here, Ay represents the maximum value of the voltage or current applied to the second drive unit 18 and Ty represents the period of a basic vibration of the second drive unit 18.

Vy=Ay×cos(2π×t/Ty−P) Expression 2

That is, the driving waveforms shown in FIG. 8 are output to the first drive unit 17 and the second drive unit 18 from the controller 7 at a certain instant.

Here, since the magnetic forces of the two magnets 42a and 42b of the first drive unit 17 are constant, the speed in the first direction X of the first moving frame 13 is correlated with the voltage value or the current value Vx applied to the first drive unit 17. The driving force to one side of the first direction X is generated in the first moving frame 13 when the voltage value or current value Vx is +, and the driving force to the other side in the first direction X is generated when the voltage value or current value Vx is −. Accordingly, the first moving frame 13 vibrates in the first direction X with a period of Tx.

Similarly, since the magnetic forces of the two magnets 52a and 52b of the second drive unit 18 are constant, the speed in the second direction Y of the second moving frame 14 is correlated with the voltage value or the current value Vy applied to the second drive unit 18. The driving force to one side in the second direction Y is generated in the second moving frame 14 when the voltage value or current value Vy is +, and the driving force to the other side in the second direction Y is generated when the voltage value or current value Vy is −. Accordingly, the second moving frame 14 vibrates in the second direction Y with a period of Ty.

The phase difference P given for the control of the first drive unit 17 and the second drive unit 18 is calculated, for example, using Expression 3. Here, Tp represents the repeated period (period) of a dynamic phase difference, Pa represents the maximum value of the dynamic phase difference, and Pp represents a static phase difference.

P=Pa×sin(2π×t/Tp)+Pp Expression 3

In this way, the controller 7 sequentially changes the phase difference P given for the control of the first drive unit 17 and the second drive unit 18 at every time t. Here, as described above, the voltage value or current value Vx applied to the first drive unit 17 is proportional to the speed of the first moving frame 13. The voltage value or current value Vy applied to the second drive unit 18 is proportional to the speed of the second moving frame 14. As a result, by changing the phase difference between the signals applied to the first drive unit 17 and the second drive unit 18, the phase difference between the vibration of the first moving frame 13 in the first direction X and the vibration of the second moving frame 14 in the second direction Y is also changed.

By synthesizing the vibration of the first moving frame 13 in the first direction X and the vibration of the second moving frame 14 in the second direction Y, a point of the diffuser 16 draws the driving locus shown in FIG. 10.

As shown in FIG. 10, by changing the phase difference P between the vibration in the first direction X and the vibration in the second direction Y, the length of the track drawn by a point of the diffuser 16 can be extended. As a result, compared with the case where the diffuser is rotated and driven, it is possible to extend the interval (hereinafter, referred to as “driving period”) between the times when a point of the diffuser 16 passes through the same locus.

Therefore, compared with the case where the diffuser 16 is rotated, it is possible to reduce the number of times (the number of times of passing through the same driving locus) of passing through the same area per a predetermined time. That is, since the diffuser 16 is driven in the track not passing through the same locus for a predetermined time, it is possible to allow a user hardly to recognize the dust attached to the diffuser 16 or the pattern defect. Accordingly, it is possible to suppress deterioration in image quality due to the attachment of dust or the pattern defect.

When the driving speed of the diffuser 16 is slowed down, a user can easily recognize the dust attached to the patterned surface of the diffuser 16 or the pattern defect. Accordingly, the controller 7 controls the first drive unit 17 and the second drive unit 18 to drive the diffuser 16 at a speed greater than a predetermined speed (speed at which the attached dust or the pattern defect is not recognized by the user).

For example, when the size of the two-dimensional intermediate image is 18 mm×32 mm and the dust or the pattern defect with a diameter of 50 μm is intended not to influence the image quality, it is necessary to set the driving speed of the diffuser 16 equal to or greater than 100 mm/s. Accordingly, the phase difference is changed by 10° in the range of ±20° by allowing the first moving frame 13 and the second moving frame 14 to vibrate with an amplitude of 4 mm and a frequency of 5 Hz. Therefore, it is possible to allow a user hardly to recognize the dust or the pattern defect, thereby preventing or suppressing the deterioration in image quality.

It is preferable that the frequency at which the first moving frame 13 and the second moving frame 14 are driven by the first drive unit 17 and the second drive unit 18 is set to be lower than the resonance frequency of the tension coil springs 61 and 62A to 62D. For example, when the resonance frequency of the tension coil springs 61 and 62A to 62D is 8 Hz, the driving frequency is set to 5 Hz. Accordingly, even in use for a long time, it is possible to prevent or suppress the two moving frames 13 and 14 from resonating with the tension coil springs 61 and 62A to 62D to collide with a stopper or the like during the driving. As a result, it is possible to extend the lifetime of the sliding mechanism of the diffuser driving device 5 and also to reduce the noise or the power consumption.

When the driving frequency is set to be higher than the resonance frequency of the tension coil springs 61 and 62A to 62D, it is possible to obtain the speckle reducing effect or the effect of suppressing the deterioration in image quality due to the dust or the pattern defect, similarly to the case where the driving frequency is lower than the resonance frequency.

The driving frequency may be set to be equal to the resonance frequency of the tension coil springs 61 and 62A to 62D. Accordingly, it is possible to further reduce the power consumption by using the resonance with the tension coil springs 61 and 62A to 62D. When the driving frequency is set to be equal to the resonance frequency of the tension coil springs 61 and 62A to 62D, it is necessary to control the resonance amplitude so as to prevent the two moving frames 13 and 14 from colliding with the stopper or the like during the driving.

To more accurately control the driving locus of the diffuser 16, a position detecting sensor for detecting the sliding positions of the first moving frame 13 and the second moving frame 14 may be provided. For example, a hole device or an optical position sensor such as a linear encoder and a PSD (Position Sensitive Detector) may be used as the position detecting sensor. The position detecting sensor is electrically connected to the controller 7 and outputs the position information of the first moving frame 13 and the second moving frame 14 to the controller 7. Then, the controller 7 controls the voltage value or current value applied to the first coil 41 of the first drive unit 17 and the second coil 51 of the second drive unit 18 on the basis of the input position information. Accordingly, it is possible to accurately control the driving locus of the diffuser 16 depending on the position thereof.

### 2. Second Embodiment

### Configuration of Diffuser Driving Device

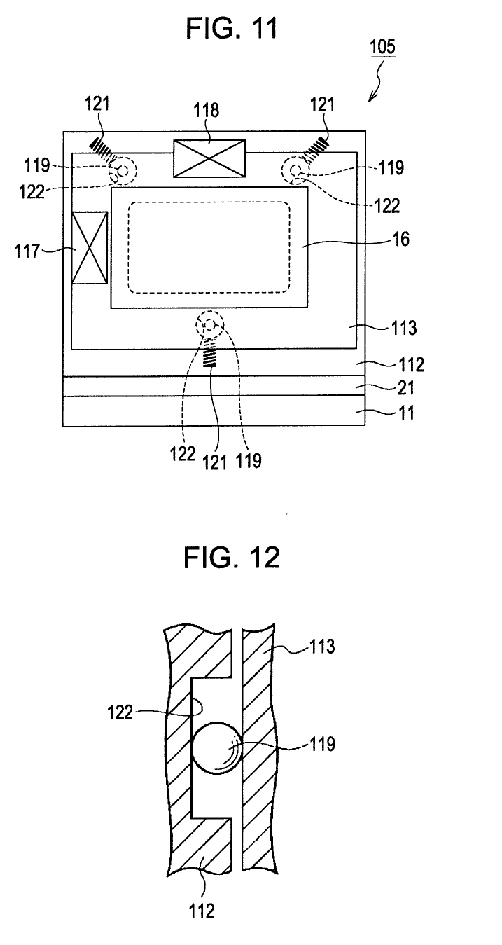

A diffuser driving device according to a second embodiment of the invention will be described now with reference to FIGS. 11 and 12. FIG. 11 is a plan view schematically illustrating a diffuser driving device according to the second embodiment of the invention and FIG. 12 is a diagram illustrating a part of the diffuser driving device according to the second embodiment of the invention.

In the diffuser driving device 105 according to the second embodiment, the moving frames for holding the diffuser 16 are combined into one body. As shown in FIG. 11, the diffuser driving device 105 includes a supporting frame 112, a moving frame 113 holding the diffuser 16, two drive units 117 and 118, and three spherical members 119.

The moving frame 113 is supported by the supporting frame 112 with the three spherical members 119 interposed therebetween as another specific example of the guide member so as to move in two directions (the first direction X and the second direction Y) perpendicular to the third direction Z which is parallel to the optical axis of the optical system. The moving frame 113 can be made to move in the first direction X by the first drive unit 117 and can be made to move in the second direction Y by the second drive unit 118. The moving frame 113 is urged to the supporting frame 112 by three spring members 121.

As shown in FIG. 12, spherical member holding portions 122 for holding the spherical members 119 are formed in the supporting frame 112. The spherical member holding portions 122 are formed as circular concave portions with a diameter greater than the spherical members 119. The three spherical members 119 are rotatably held in the spherical member holding portions 122 formed in the supporting frame 112. The three spherical members 119 are interposed between the supporting frame 112 and the moving frame 113 in a state where they are held in the spherical member holding portions 122. Accordingly, it is possible to greatly reduce the frictional resistance among the moving frame 113, the spherical members 119, and the supporting frame 112. As a result, the drive units 117 and 118 can allow the moving frame 113 to satisfactorily vibrate with a small driving force. Since the spherical members 119 or the portions contacting with the spherical members 119 can easily be abraded to cause the deterioration or the generation of dust, it is preferable that they are formed of a material such as ceramics resistant to the abrasion.

Other configurations and operations are the same as the diffuser driving device 5 according to the first embodiment, description thereof is omitted. According to the diffuser driving device 105 having the above-mentioned configuration, it is possible to obtain the same operations and advantages as the diffuser driving device 5 according to the first embodiment.

In the diffuser driving device 105 according to the second embodiment, it is possible to reduce the number of components of the second moving frame in comparison with the diffuser driving device 5 according to the first embodiment, thereby reducing the entire size of the apparatus.

As described above, in the diffuser driving device according to the embodiments of the invention, the phase difference between the vibration of the moving frame holding the diffuser in the first direction and the vibration of the moving frame in the second direction is changed. Accordingly, it is possible to extend the driving period of the diffuser, compared with the case where the diffuser is rotated. That is, it is possible to drive the diffuser in the track not passing through the same locus for a predetermined time. The diffuser is driven at a speed greater than the speed at which the dust attached to the diffuser or the pattern defect is not recognized by a user. As a result, it is possible to allow a user hardly to recognize the dust attached to the diffuser or the pattern defect, thereby suppressing the deterioration in image quality due to the attached dust or the pattern defect.

By providing the urging member urging the moving frame to the supporting frame, it is possible to reduce the surface wobbling of the diffuser in the optical axis direction during the driving, thereby obtaining an excellent focus of a projected image. By setting the size of the diffuser to be slightly greater than the surface size of the two-dimensional intermediate image, it is possible to reduce the cost of the diffuser, compared with the case where the diffuser is rotated.

The invention is not limited to the embodiments shown in the drawings, but may be modified in various forms without departing from the spirit and scope of the appended claims. For example, the configuration of the optical block forming and projecting the image beam (two-dimensional intermediate image) is not limited to the above-mentioned embodiments. That is, an optical block using plural light-emitting portions or another laser as a light source may be employed.

The diffuser and the moving frame may be formed in a body, a coil or the like constituting the drive unit may be fixed to the diffuser, and then the diffuser may be driven.

The present application contains subject matter related to that disclosed in Japanese Priority Patent Application No. 2008-290394 filed in the Japan Patent Office on Nov. 12, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A diffuser driving device comprising:
a moving frame mounted with a diffuser;
a supporting frame movably supporting the moving frame;
a drive unit driving the moving frame to vibrate in a first direction perpendicular to an optical axis of an image beam incident on the diffuser and a second direction perpendicular to the first direction and the optical axis; and
a controller controlling the drive unit to change a phase difference between the vibration of the moving frame in the first direction and the vibration of the moving frame in the second direction and to move the moving frame at a moving speed higher than a predetermined value.

2. The diffuser driving device according to claim 1, further comprising an urging member urging the moving frame toward the supporting frame.

3. The diffuser driving device according to claim 2, wherein the controller controls the drive unit to move the moving frame at a frequency lower than the resonance frequency of the urging member.

4. The diffuser driving device according to claim 1, wherein the moving frame includes a first moving frame holding the diffuser and being movable in the first direction and a second moving frame movably supporting the first moving frame and being movable in the second direction, and
wherein the drive unit includes a first drive unit driving the first moving frame to move in the first direction and a second drive unit driving the second moving frame to move in the second direction.

5. The diffuser driving device according to claim 1, wherein the supporting frame includes a guide member guiding the moving frame in the first direction and the second direction, and
wherein the guide member is disposed to avoid the upside in the gravitational direction of the diffuser mounted on the supporting frame.

6. The diffuser driving device according to claim 5, wherein the guide member includes at least three spherical members interposed between the moving frame and the supporting frame.

7. A projection-type image display apparatus comprising:
an optical block forming and projecting an image beam;
a projection lens magnifying and projecting the image beam to a display unit; and
a diffuser driving device being disposed between the optical block and the projection lens and including a diffuser on which the image beam from the optical block is incident,
wherein the diffuser driving device includes
a moving frame mounted with the diffuser,
a supporting frame movably supporting the moving frame,
a drive unit driving the moving frame to vibrate in a first direction perpendicular to an optical axis of the image beam incident on the diffuser and a second direction perpendicular to the first direction and the optical axis, and
a controller controlling the driving unit to change a frequency or a phase difference between the vibration of the moving frame in the first direction and the vibration of the moving frame in the second direction and to move the moving frame at a moving speed higher than a predetermined value.
